(19) United States
(12) Patent Application Publication
(10) Pub. No.: US 2015/0138165 A1
(43) Pub. Date: May 21, 2015

(54) Replaceable Tip for Active Stylus

(71) Applicant: Nigel Hinson, Lymington (GB)

(72) Inventor: Nigel Hinson, Lymington (GB)

(21) Appl. No.: 14/086,735

(22) Filed: Nov. 21, 2013

(51) Int. Cl. G06F 3/0354; G06F 3/038

(52) U.S. Cl. CPC G06F 3/03545; G06F 3/0383
USPC 345/179

(57) ABSTRACT

In one embodiment, an active-stylus tip includes a collar that includes substantially flexible material configured to secure the active-stylus tip to an end of an active stylus. The collar enables the active-stylus tip to be readily removed from the end of the active stylus. The active stylus includes one or more electrodes and one or more computer-readable non-transitory storage media embodying logic for wirelessly transmitting signals to a device through a touch sensor of the device. The active-stylus tip includes a nib having a tapered end opposite the collar. The nib further includes an element opposite the tapered end of the nib, where the element is configured to engage a force sensor disposed in the active stylus and communicate a force applied to the nib to the force sensor. The active-stylus tip also includes a neck mechanically connecting the nib to the collar and enabling the active-stylus tip to flex.

### TECHNICAL FIELD

This disclosure generally relates to replaceable tips for active styluses.

### BACKGROUND

A touch sensor may detect the presence and location of a touch or the proximity of an object (such as a user's finger or a stylus) within a touch-sensitive area of the touch sensor overlaid on a display screen, for example. In a touch-sensitive-display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

### BRIEF DESCRIPTION OF THE DRAWINGS

FIG. 1 illustrates an example touch sensor with an example touch-sensor controller.

FIG. 2 illustrates an example active stylus exterior.

FIG. 3 illustrates an example active stylus interior.

FIG. 4 illustrates an example active stylus with an example device.

FIG. 5 illustrates a side view of an example tip.

FIG. 6 illustrates a perspective view of an example tip.

FIG. 7 illustrates a cross-sectional view of an example collar of an example tip and a cross-sectional view of an example tip region.

FIG. 8 illustrates an example tip being attached to an example tip region of an example active stylus.

FIG. 9 illustrates the example tip of FIG. 8 after being attached to the example tip region of FIG. 8.

FIG. 10 illustrates an example tip being flexed about an example neck.

FIG. 11 illustrates a side view of another example tip.

FIG. 12 illustrates an example tip region with the example tip of FIG. 11 attached.

### DESCRIPTION OF EXAMPLE EMBODIMENTS

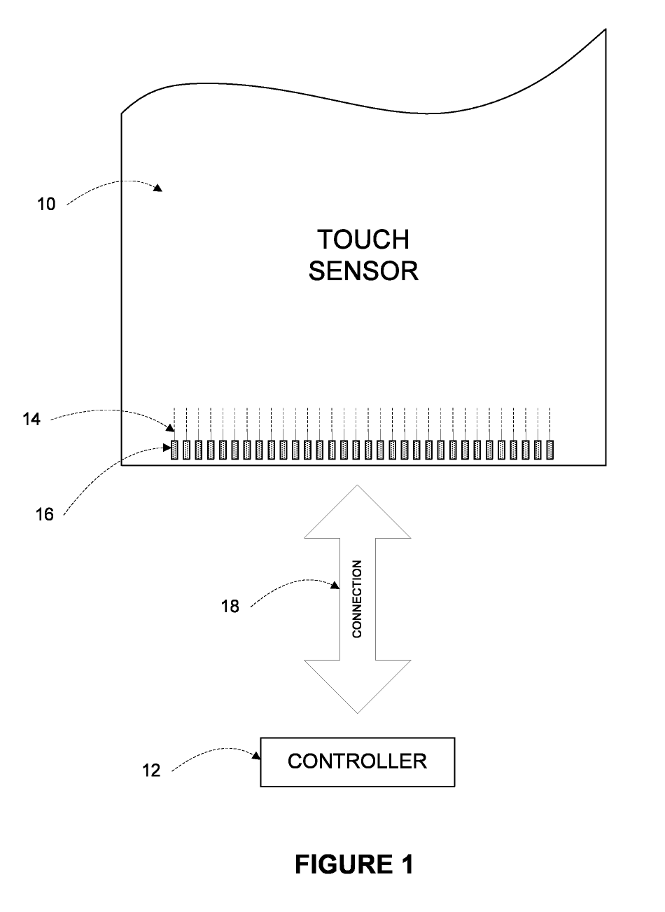

FIG. 1 illustrates an example touch sensor 10 with an example touch-sensor controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a ground electrode, a guard electrode, a drive electrode, or a sense electrode) may be an area of conductive material forming a shape, such as for example a disc, square, rectangle, thin line, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape (sometimes referred to as 100% fill), where appropriate. In particular embodiments, the conductive material of an electrode may occupy substantially less than 100% of the area of its shape. As an example and not by way of limitation, an electrode may be made of fine lines of metal or other conductive material (FLM), such as for example copper, silver, or a copper- or silver-based material, and the fine lines of conductive material may occupy approximately 5% of the area of its shape in a hatched, mesh, or other suitable pattern. Herein, reference to FLM encompasses such material, where appropriate. Although this disclosure describes or illustrates particular electrodes made of particular conductive material forming particular shapes with particular fill percentages having particular patterns, this disclosure contemplates any suitable electrodes made of any suitable conductive material forming any suitable shapes with any suitable fill percentages having any suitable patterns.

Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space, or gap, between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such as one or more central processing units (CPUs)) of a device that includes touch sensor 10 and touch-sensor controller 12, which may respond to the touch or proximity input by initiating a function of the device (or an application running on the device). Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. The FPC may be active or passive, where appropriate. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

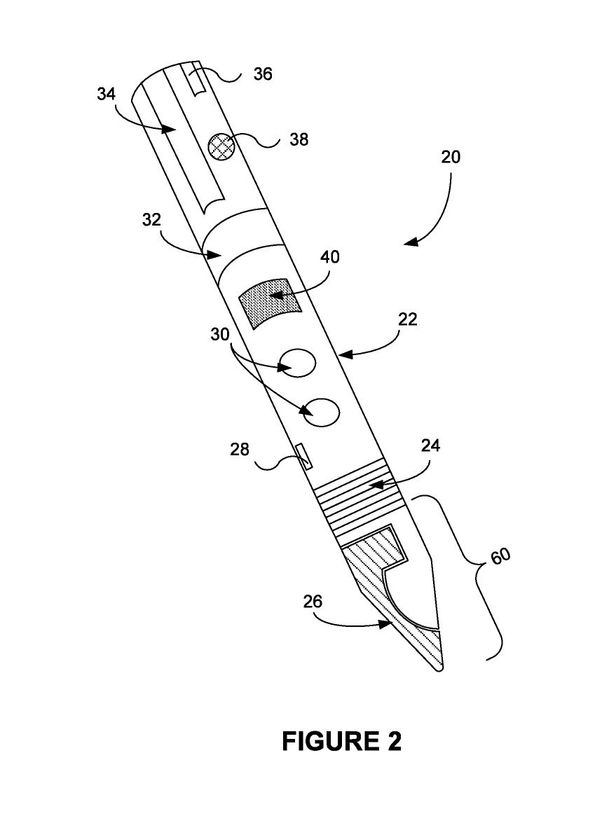

FIG. 2 illustrates an example exterior of an example active stylus 20, which may be used in conjunction with touch sensor 10 of FIG. 1. In particular embodiments, active stylus 20 is powered (e.g., by an internal or external power source) and is capable of providing touch or proximity inputs to a touch sensor (e.g., touch sensor 10 illustrated in FIG. 1). Active stylus 20 may include one or more components, such as buttons 30 or sliders 32 and 34 integrated with an outer body 22. These external components may provide for interaction between active stylus 20 and a user or between a device and a user. As an example and not by way of limitation, interactions may include communication between active stylus 20 and a device, enabling or altering functionality of active stylus 20 or a device, or providing feedback to or accepting input from one or more users. The device may be any suitable device, such as, for example and without limitation, a desktop computer, laptop computer, tablet computer, personal digital assistant (PDA), smartphone, satellite navigation device, portable media player, portable game console, kiosk computer, point-of-sale device, or other suitable device. Although this disclosure provides specific examples of particular components configured to provide particular interactions, this disclosure contemplates any suitable component configured to provide any suitable interaction. Active stylus 20 may have any suitable dimensions with outer body 22 made of any suitable material or combination of materials, such as, for example and without limitation, plastic or metal. In particular embodiments, exterior components (e.g., 30 or 32) of active stylus 20 may interact with internal components or programming of active stylus 20 or may initiate one or more interactions with one or more devices or other active styluses 20.

As described above, actuating one or more particular components may initiate an interaction between active stylus 20 and a user or between the device and the user. Components of active stylus 20 may include one or more buttons 30 or one or more sliders 32 and 34. As an example and not by way of limitation, buttons 30 or sliders 32 and 34 may be mechanical or capacitive and may function as a roller, trackball, or wheel. As another example, one or more sliders 32 or 34 may function as a vertical slider 34 aligned along a longitudinal axis of active stylus 20, while one or more wheel sliders 32 may be aligned around the circumference of active stylus 20. In particular embodiments, capacitive sliders 32 and 34 or buttons 30 may be implemented using one or more touch-sensitive areas. Touch-sensitive areas may have any suitable shape, dimensions, location, or be made from any suitable material. As an example and not by way of limitation, sliders 32 and 34 or buttons 30 may be implemented using areas of flexible mesh formed using lines of conductive material. As another example, sliders 32 and 34 or buttons 30 may be implemented using an FPC.

Active stylus 20 may have one or more components configured to provide feedback to or accept feedback from a user, such as, for example and without limitation, tactile, visual, or audio feedback. Active stylus 20 may include one or more ridges or grooves 24 on its outer body 22. Ridges or grooves 24 may have any suitable dimensions, have any suitable spacing between ridges or grooves, or be located at any suitable area on outer body 22 of active stylus 20. As an example and not by way of limitation, ridges 24 may enhance a user's grip on outer body 22 of active stylus 20 or provide tactile feedback to or accept tactile input from a user. Active stylus 20 may include one or more audio components 38 capable of transmitting and receiving audio signals. As an example and not by way of limitation, audio component 38 may contain a microphone capable of recording or transmitting one or more users' voices. As another example, audio component 38 may provide an auditory indication of a power status of active stylus 20. Active stylus 20 may include one or more visual feedback components 36, such as a light-emitting diode (LED) indicator or an electrophoretic display. As an example and not by way of limitation, visual feedback component 36 may indicate a power status of active stylus 20 to the user.

One or more modified surface areas 40 may form one or more components on outer body 22 of active stylus 20. Properties of modified surface areas 40 may be different than properties of the remaining surface of outer body 22. As an example and not by way of limitation, modified surface area 40 may be modified to have a different texture, temperature, or electromagnetic characteristic relative to the surface properties of the remainder of outer body 22. Modified surface area 40 may be capable of dynamically altering its properties, for example by using haptic interfaces or rendering techniques. A user may interact with modified surface area 40 to provide any suitable functionality. For example and not by way of limitation, dragging a finger across modified surface area 40 may initiate an interaction, such as data transfer, between active stylus 20 and a device.

One or more components of active stylus 20 may be configured to communicate data between active stylus 20 and the device. For example, active stylus 20 may have a tip region 60 located at an end of active stylus 20, and tip region 60 may include one or more tips 26 or nibs. Tip region 60 or tip 26 may include one or more electrodes configured to communicate data between active stylus 20 and one or more devices or other active styluses. In particular embodiments, tip region 60 may include one or more transmit electrodes and one or more receive electrodes. By way of example and without limitation, the electrodes of active stylus 20 may reside on outer body 22 of active stylus, in active-stylus tip 26 or tip region 60, or on or in any other suitable part of active stylus 20. Tip region 60 and tip 26 may provide or communicate pressure or force information (e.g., the amount of pressure or force being exerted by or on active stylus 20 through tip 26) between active stylus 20 and one or more devices or other active styluses. Tip 26 may be made of any suitable material, such as a conductive material, an insulating or non-conductive material, or any suitable combination of conductive and non-conductive materials. Tip 26 may have any suitable dimensions, such as, for example, a diameter of 1 mm or less at its terminal end. Active stylus 20 may include one or more ports 28 located at any suitable location on outer body 22 of active stylus 20. Port 28 may be configured to transfer signals or information between active stylus 20 and one or more devices or power sources via, for example, wired coupling. Port 28 may transfer signals or information by any suitable technology, such as, for example, by universal serial bus (USB) or Ethernet connections. Although this disclosure describes and illustrates a particular configuration of particular components with particular locations, dimensions, composition and functionality, this disclosure contemplates any suitable configuration of suitable components with any suitable locations, dimensions, composition, and functionality with respect to active stylus 20.

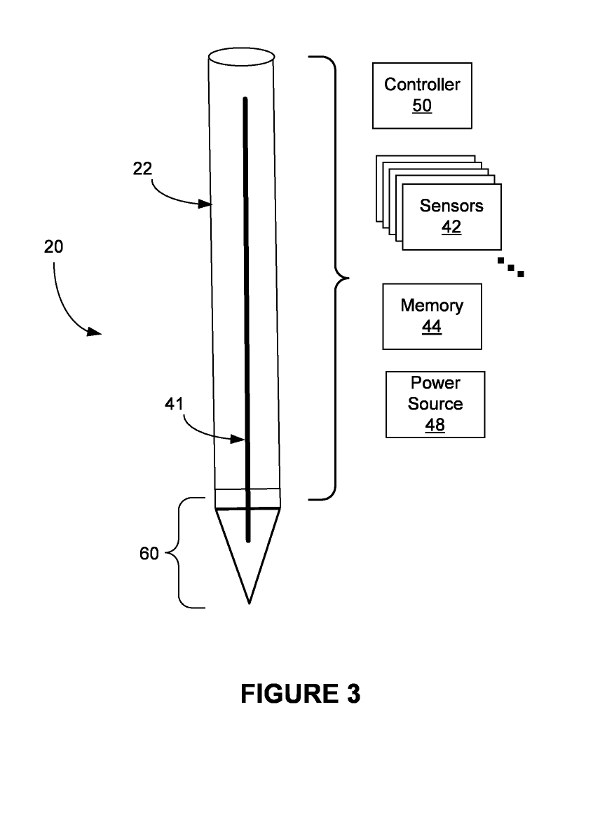

FIG. 3 illustrates example internal components of an example active stylus 20. Active stylus 20 includes one or more components, such as a controller 50, sensors 42, memory 44, or power source 48. In particular embodiments, one or more components may be configured to provide for interaction between active stylus 20 and a user or between a device and a user. In other particular embodiments, one or more internal components, in conjunction with one or more external components described above, may be configured to provide interaction between active stylus 20 and a user or between a device and a user. As an example and not by way of limitation, interactions may include communication between active stylus 20 and a device, enabling or altering functionality of active stylus 20 or a device, or providing feedback to or accepting input from one or more users. As another example, active stylus 20 may communicate via any applicable short distance, low energy data transmission or modulation link, such as, for example and without limitation, via a radio frequency (RF) communication link. In this case, active stylus 20 includes a RF device for transmitting data over the RF link.

Controller 50 may be a microcontroller or any other type of computing device or processor suitable for controlling the operation of active stylus 20. Controller 50 may be one or more ICs—such as, for example, general-purpose microprocessors, microcontrollers, programmable logic devices (PLDs), programmable logic arrays (PLAs), or ASICs. Controller 50 may include a processor unit, a drive unit, a sense unit, and a storage unit. In particular embodiments, a processor unit in controller 50 may control the operation of electrodes in active stylus 20, either via drive or sense units or directly. The drive unit may supply signals to one or more electrodes of tip region 60 through conduit 41. In particular embodiments, conduit 41 may electrically couple one or more electrodes or sensors in tip region 60 to controller 50. In particular embodiments, conduit 41 may include electrical wiring, an FPC, a section of an FPC, or any suitable means for coupling an electrical line or signal between electrical devices or components. The drive unit may also supply signals to control or drive sensors 42 or one or more external components of active stylus 20. In particular embodiments, the drive unit of active stylus 20 may be configured to transmit a signal that may be detected by electrodes of touch sensor 10. As an example and not by way of limitation, the drive unit of active stylus 20 may include a voltage pump or a switch, such that the voltage pump may generate a high voltage signal, or the switch may toggle the potential of tip 26 between zero voltage and one or more pre-determined voltage levels. The drive unit of active stylus 20 may transmit a signal, such as a square wave, sine wave, or digital-logic signal, that may be sensed by the electrodes of touch sensor 10. In particular embodiments, the drive unit of active stylus 20 may transmit a signal to the electrodes of touch sensor 10 by applying a voltage or current to electrodes of tip region 60 that results in charge removal or charge addition to the electrodes of touch sensor 10, mimicking a touch or anti-touch of a finger on a pulse-by-pulse basis.

The sense unit may sense signals received by electrodes of tip region 60 through conduit 41 and provide measurement signals to the processor unit representing input from a device. The sense unit may also sense signals generated by sensors 42 or one or more external components and provide measurement signals to the processor unit representing input from a user. The processor unit may control the supply of signals to the electrodes of tip region 60 and process measurement signals from the sense unit to detect and process input from the device. The processor unit may also process measurement signals from sensors 42 or one or more external components. The storage unit may store programming for execution by the processor unit, including programming for controlling the drive unit to supply signals to the electrodes of tip region 60, programming for processing measurement signals from the sense unit corresponding to input from the device, programming for processing measurement signals from sensors 42 or external components to initiate a pre-determined function or gesture to be performed by active stylus 20 or the device, and other suitable programming, where appropriate. As an example and not by way of limitation, programming executed by controller 50 may electronically filter signals received from the sense unit. Although this disclosure describes a particular controller 50 having a particular implementation with particular components, this disclosure contemplates any suitable controller having any suitable implementation with any suitable components.

In particular embodiments, active stylus 20 may include one or more sensors 42, such as touch sensors, force sensors, gyroscopes, accelerometers, contact sensors, or any other type of sensor that detect or measure data about the environment in which active stylus 20 operates. Sensors 42 may detect and measure one or more characteristic of active stylus 20, such as acceleration or movement, orientation, force, contact, pressure on outer body 22, force on tip 26, vibration, or any other suitable characteristic of active stylus 20. In particular embodiments, tip region 60 may include a force sensor (e.g., a piezoelectric force sensor) for measuring a force applied to tip 26. As an example and not by way of limitation, sensors 42 may be implemented mechanically, electronically, or capacitively. As described above, data detected or measured by sensors 42 communicated to controller 50 may initiate a pre-determined function or gesture to be performed by active stylus 20 or the device. In particular embodiments, data detected or received by sensors 42 may be stored in memory 44. Memory 44 may be any form of memory suitable for storing data in active stylus 20. In other particular embodiments, controller 50 may access data stored in memory 44. As an example and not by way of limitation, memory 44 may store programming for execution by the processor unit of controller 50. As another example, data measured by sensors 42 may be processed by controller 50 and stored in memory 44.

Power source 48 may be any type of stored-energy source, including electrical or chemical-energy sources, suitable for powering the operation of active stylus 20. In particular embodiments, power source 48 may include a primary battery, such as for example an alkaline battery, or a rechargeable battery, such as for example a lithium-ion or nickel-metal-hydride battery. In particular embodiments, power source 48 may be charged by energy from a user or device. As an example and not by way of limitation, power source 48 may be a rechargeable battery that may be charged by motion induced on active stylus 20. In other particular embodiments, power source 48 of active stylus 20 may provide power to or receive power from the device or other external power source. As an example and not by way of limitation, power may be inductively transferred between power source 48 and a power source of the device or another external power source, such as a wireless power transmitter. Power source may also be powered or recharged by a wired connection through an applicable port coupled to a suitable power source.

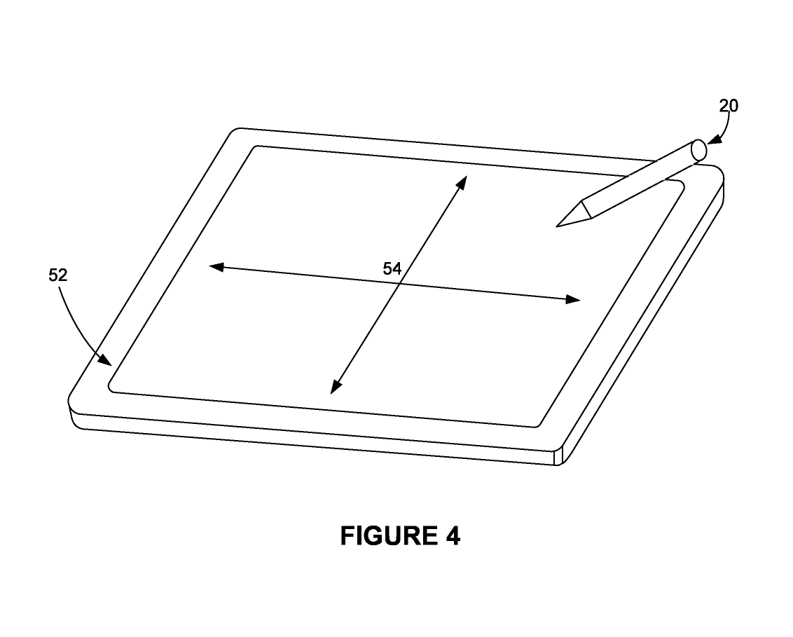

FIG. 4 illustrates an example active stylus 20 with an example device 52. One example of device 52 is touch screen 10 of FIG. 1. Device 52 may have a display (not shown) and a touch sensor with a touch-sensitive area 54. Device 52 display may be a liquid crystal display (LCD), a LED display, a LED-backlight LCD, or other suitable display and may be visible though a cover panel and substrate (and the drive and sense electrodes of the touch sensor disposed on it) of device 52. Although this disclosure describes a particular device display and particular display types, this disclosure contemplates any suitable device display and any suitable display types.

Device 52 electronics may provide the functionality of device 52. As an example and not by way of limitation, device 52 electronics may include circuitry or other electronics for wireless communication to or from device 52, executing programming on device 52, generating graphical or other user interfaces (UIs) for device 52 display to display to a user, managing power to device 52 from a battery or other power source, taking still pictures, recording video, other suitable functionality, or any suitable combination of these. Although this disclosure describes particular device electronics providing particular functionality of a particular device, this disclosure contemplates any suitable device electronics providing any suitable functionality of any suitable device.

In particular embodiments, active stylus 20 and device 52 may be synchronized prior to communication of data between active stylus 20 and device 52. As an example and not by way of limitation, active stylus 20 may be synchronized to device 52 through a pre-determined bit sequence transmitted by the touch sensor of device 52. As another example, active stylus 20 may be synchronized to device 52 by processing a drive signal transmitted by drive electrodes of the touch sensor of device 52. Active stylus 20 may interact or communicate with device 52 when active stylus 20 is brought in contact with or in proximity to touch-sensitive area 54 of the touch sensor of device 52. In particular embodiments, interaction between active stylus 20 and device 52 may be capacitive or inductive. As an example and not by way of limitation, when active stylus 20 is brought in contact with or in the proximity of touch-sensitive area 54 of device 52, signals generated by active stylus 20 may influence capacitive nodes of touch-sensitive area of device 52 or vice versa. Although this disclosure describes particular interactions and communications between active stylus 20 and device 52, this disclosure contemplates any suitable interactions and communications through any suitable means, such as mechanical forces, current, voltage, or electromagnetic fields.

In particular embodiments, measurement signal from the sensors of active stylus 20 may initiate, provide for, or terminate interactions between active stylus 20 and one or more devices 52 or one or more users, as described above. Interaction between active stylus 20 and device 52 may occur when active stylus 20 is contacting or in proximity to device 52. As an example and not by way of limitation, a user may perform a gesture or sequence of gestures, such as shaking or inverting active stylus 20, whilst active stylus 20 is hovering above touch-sensitive area 54 of device 52. Active stylus may interact with device 52 based on the gesture performed with active stylus 20 to initiate a pre-determined function, such as authenticating a user associated with active stylus 20 or device 52. Although this disclosure describes particular movements providing particular types of interactions between active stylus 20 and device 52, this disclosure contemplates any suitable movement influencing any suitable interaction in any suitable way.

Active stylus 20 may receive signals from external sources, including device 52, a user, or another active stylus. Active stylus 20 may encounter noise when receiving such signals. As examples, noise may be introduced into the received signals from data quantization, limitations of position-calculation algorithms, bandwidth limitations of measurement hardware, accuracy limitations of analog front ends of devices with which active stylus 20 communicates, the physical layout of the system, sensor noise, charger noise, device noise, noise from device 52 display, stylus circuitry noise, or external noise. The overall noise external to active stylus 20 may have frequency characteristics covering a wide range of the spectrum, including narrow-band noise and wide-band noise, as well.

In particular embodiments, a signal may be received by one or more electrodes capable of sensing signals in active stylus 20. These electrodes may reside in active-stylus tip 26 or tip region 60. The signal received by the electrodes in active stylus 20 may then be transmitted from the electrodes to controller 50. In particular embodiments, a signal may be transmitted to controller 50 via conduit 41. Controller 50, as discussed above, may include, without limitation, a drive unit, a sense unit, a storage unit, and a processor unit. In particular embodiments, a received signal may be amplified by any suitable amplifier, including a digital or an analog amplifier. In particular embodiments, a received signal may be filtered by any suitable filter, including a digital or an analog filter. In particular embodiments, device 52 may transmit data to active stylus 20 by sending data to one or more drive electrodes of touch sensor 10, and active stylus 20 may receive data via electrodes of tip region 60. In particular embodiments, after active stylus 20 and device 52 are synchronized, active stylus 20 may transmit data to device 52 by performing charge addition or charge removal on one or more sense electrodes of touch sensor 10, and device 52 may receive data sent from active stylus 20 by sensing data with one or more sense electrodes of touch sensor 10.

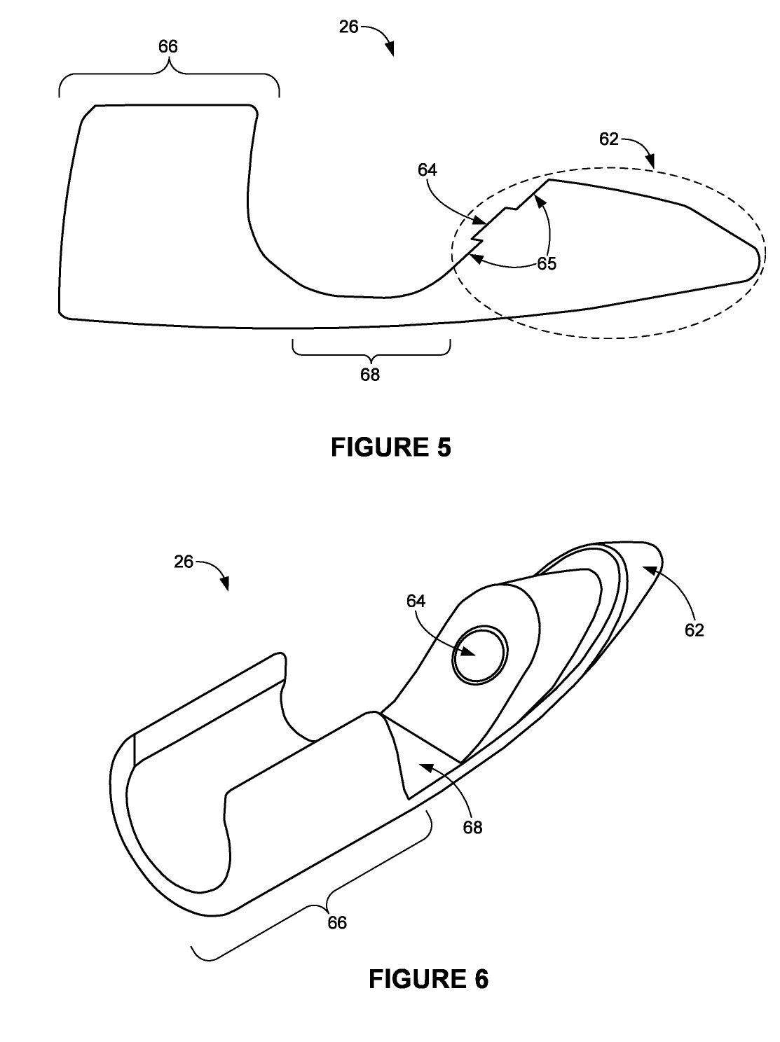

FIG. 5 illustrates a side view of an example tip 26. In particular embodiments, tip 26 may be a replaceable tip that clips or snaps on to tip region 60 of active stylus 20. The example tip 26 of FIG. 5 includes a nib portion 62, and the nib portion 62 (or, nib) may be used to make contact with or interact with touch sensor 10. In particular embodiments, nib 62 may have a tapered or rounded shape. In particular embodiments, nib 62 may include an end that terminates in a round or spherical shape with a radius of between approximately 0.25 mm and 2.5 mm. In particular embodiments, nib 62 may terminate in a substantially sharp or pointed end. In particular embodiments, a portion of nib 62 may have a tapered shaped, and nib 62 may terminate in a substantially blunt or flat end. In particular embodiments, nib 62 may terminate in a brush-like feature having multiple end projections that extend substantially parallel to one another along an axis of stylus 20. In particular embodiments, exterior portion of nib 62 may have a substantially smooth texture or surface finish. In particular embodiments, exterior portion of nib 62 may include a textured surface or a surface with substantial surface roughness. Although this disclosure describes and illustrates particular tips 26 having particular nibs 62 with particular shapes and textures, this disclosure contemplates any suitable tips 26 having any suitable nibs 62 with any suitable shapes and textures.

In particular embodiments, nib 62 may include a contact pad 64 having a raised portion that protrudes above a surrounding surface 65. In the example of FIG. 5, nib 62 includes contact pad 64 opposite the tapered end of nib 62. In particular embodiments, nib 62 may include one or more transmit electrodes for sending or transmitting a signal to device 52. In particular embodiments, nib 62 may include one or more receive electrodes for receiving a signal from device 52. In particular embodiments, contact pad may make electrical contact with conduit 41 for coupling transmit or receive signals between nib 62 and controller 50. In particular embodiments, contact pad 64 may make mechanical contact with or may be mechanically engaged with a force sensor disposed in tip region 60.

In FIG. 5, tip 26 includes a collar region 66. In particular embodiments, collar region 66 (or, collar) may be made of a substantially flexible or springy material. In particular embodiments, collar 66 may secure, clamp, or attach tip 26 to a portion of tip region 60. In particular embodiments, collar 66 may include a C-shaped portion that mechanically engages in a sideways manner with a mating portion of tip region 60. In particular embodiments, when tip 26 is secured to tip region 60, collar 66 may partially encircle or be wrapped around a portion of tip region 60.

In the example of FIG. 5, tip 26 includes a neck portion 68, and neck portion 68 (or, neck) may mechanically link, couple, or connect nib 62 to collar 66. In particular embodiments, neck 68 may have a thickness, diameter, or width that is narrower than a thickness, diameter, or width of nib 62 or collar 66. In particular embodiments, neck 68 may enable tip 26 to flex as a force is applied to an end of nib 62. In particular embodiments, a user may hold active stylus 20 and press nib 62 against touch sensor 10 surface, resulting in a flex or bending movement of neck 68. In particular embodiments, collar 66 may be attached to a portion of tip region 60, and as neck 68 flexes due to an applied force, nib 62 may experience a movement or displacement relative to tip region 60 and active stylus 20.

FIG. 6 illustrates a perspective view of an example tip 26 similar to the tip 26 of FIG. 5. The example tip 26 in FIG. 6 includes a nib 62, a contact pad 64, a collar 66, and a neck 68, similar to those elements described above. Particular tips 26 may include one or more nibs 62, contact pads 64, collars 66, or necks 68. In particular embodiments, a tip 26 may not include a nib 62, may not include a contact pad 64, may not include a collar 66, or may not include a neck 68. Although this disclosure describes and illustrates particular tips 26 having particular nibs 62, contact pads 64, collars 66, or necks 68, this disclosure contemplates any suitable tips 26 having any suitable nibs 62, contact pads 64, collars 66, or necks 68.

In particular embodiments, tip 26 may include a single piece made of a single material. In particular embodiments, tip 26 may include two or more pieces or two or more materials, which are joined, attached, or molded together to form a single tip 26. In particular embodiments, tip 26 may include two or more pieces, where each piece is made from a different material. In particular embodiments, tip 26 may be made of an electrically conductive material. In particular embodiments, tip 26 may be made of an electrically insulating (or, electrically nonconductive material). In particular embodiments, tip 26 may be made of one or more electrically conductive materials and one or more electrically insulating materials that are joined or attached together to form a single tip 26. In particular embodiments, tip 26 may include one or more pieces made from one or more of the following materials: plastic, thermoplastic, thermosetting plastic, acrylonitrile butadiene styrene (ABS), acrylic, nylon, polyethylene, polypropylene, polyvinyl chloride, polyoxymethylene, polymer, epoxy, resin, or rubber. In particular embodiments, tip 26 may include one or more pieces made from an electrically conductive material, such as for example electrically conductive plastic, electrically conductive polymer, electrically conductive resin, or electrically conductive rubber. In particular embodiments, an electrically conductive plastic material may include a plastic material (e.g., ABS) combined with an electrically conductive material, such as for example carbon or steel fibers, a conductive metal (e.g., copper, aluminum), a conductive form of carbon, carbon nanotubes, or graphite. As an example and not by way of limitation, tip 26 may be made of an electrically conductive material (e.g., a plastic material combined with electrically conductive carbon particles) and an electrically insulating material (e.g., ABS) that are joined, attached, or molded together to form a single tip 26. Although this disclosure describes and illustrates particular tips 26 made of particular materials, this disclosure contemplates any suitable tips 26 made of any suitable materials.

In particular embodiments, tip 26 may be made of a single material and may be formed in an injection-molding process. In particular embodiments, tip 26 may be made from a thermoplastic material or a thermosetting material using an injection-molding process. In particular embodiments, tip 26 may be made from two injection-molded pieces that are joined together (e.g., with epoxy or by heating) after an injection-molding process. In particular embodiments, tip 26 may be made of two different materials, and tip 26 may be formed in a twin-shot or two-part injection-molding process where the two different materials are injected into one or more molds in a two-step process. As an example and not by way of limitation, tip 26 may be made of two materials (e.g., one electrically conductive plastic and one electrically insulating plastic), and tip 26 may be formed in a twin-shot injection-molding process. As another example, tip 26 may be made of an electrically conductive material (e.g., a plastic material combined with an electrically conductive form of carbon) and an electrically insulating material (e.g., ABS), and tip 26 may be formed in a twin-shot injection-molding process. In particular embodiments, tip 26 may be formed from two or more different materials in a multi-shot injection-molding process. In particular embodiments, tip 26 may be made of one or more different materials and may be formed using an additive manufacturing (or three-dimensional printing) process. Although this disclosure describes and illustrates particular tips 26 made of one or more materials and formed by particular processes, this disclosure contemplates any suitable tips 26 may of any suitable number of materials and formed by any suitable processes.

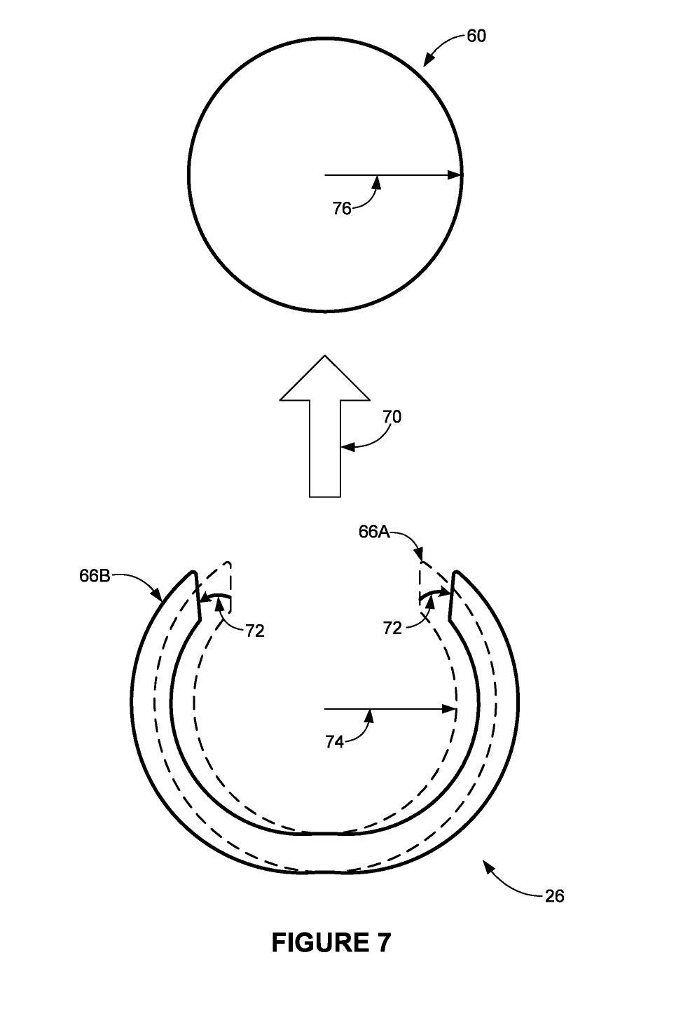

FIG. 7 illustrates a cross-sectional view of an example collar 66 of an example tip 26 and a cross-sectional view of an example tip region 60. In FIG. 7, collar 66 is viewed along a longitudinal axis of tip 26, and tip region 60 is viewed along a longitudinal axis of active stylus 20. FIG. 7 illustrates an example C-shape that may be exhibited by collar 66 when viewed along a longitudinal axis of tip 26. In particular embodiments, tip 26 may be made of one or more materials that are substantially flexible or springy and may allow one or more parts of tip 26 to be flexed or bent. In particular embodiments, tip 26 may be made of one or more materials that maintain a substantially rigid shape and also allow for some deformation or flexibility of one or more portions of tip 26. In particular embodiments, tip 26 may be formed such that tip 26 maintains a substantially rigid shape and collar 66 and neck 68 of tip 26 have some amount of flexibility. In particular embodiments, collar 66 may be deformed, flexed, or bent a certain amount when a force is applied to collar, and collar 66 may return to a substantially unperturbed shape after the force is removed. In particular embodiments, neck 68 may flex or bend when a force is applied to nib 62, and neck 68 may return to its quiescent or unperturbed position after the force is removed.

In FIG. 7, collar 66A (dashed line) represents collar 66 in an unperturbed state with no force applied to it, and collar 66B (solid line) represents a flexed or perturbed collar 66 with a force 72 applied to it. In particular embodiments, as tip 26 is attached to tip region 60, a force 72 may be applied to ends of collar 66, and collar 66 may flex open resulting in ends of collar 66 moving outward or away from one another. In particular embodiments, attaching tip 26 to tip region 60 of active stylus 20 may include expanding or increasing an opening of collar 66 as the two ends of collar 66B move apart from each other and fit over a mating portion of tip region 60. In FIG. 7, arrow 70 indicates a lateral or sideways movement of tip 26 toward tip region as tip 26 is being attached to tip region 60. In particular embodiments, the attachment movement corresponding to arrow 70 may be substantially orthogonal to a longitudinal axis of active stylus 20 and may be substantially orthogonal to a longitudinal axis of tip 26.

Once collar 66 is in place and attached to tip region 60, the two ends of collar 66A may snap back or spring back into place and collar 66A may return to its unperturbed shape. In particular embodiments, interior radius 74 of collar 66A in an unperturbed state may be approximately the same as an exterior radius 76 of tip region 60 where tip 26 mates to tip region 60. In particular embodiments, interior radius 74 of collar 66A may be slightly less than exterior radius 76, and when tip 26 is mated to tip region 60, collar 66 may settle to a slightly flexed or open state relative to its unperturbed shape 66A. In particular embodiments, having collar 66 slightly flexed open when mated to tip region 60 may provide a flexing, gripping, or restoring force that collar 66 exerts on a mating portion of tip region 60, and the flexing, gripping, or restoring force may in part provide for a secure attachment of tip 26 to tip region 60. In particular embodiments, a flexing, gripping, or restoring force may act to keep tip 26 securely attached to tip region 60 and may prevent tip 26 from becoming accidentally detached from tip region 60.

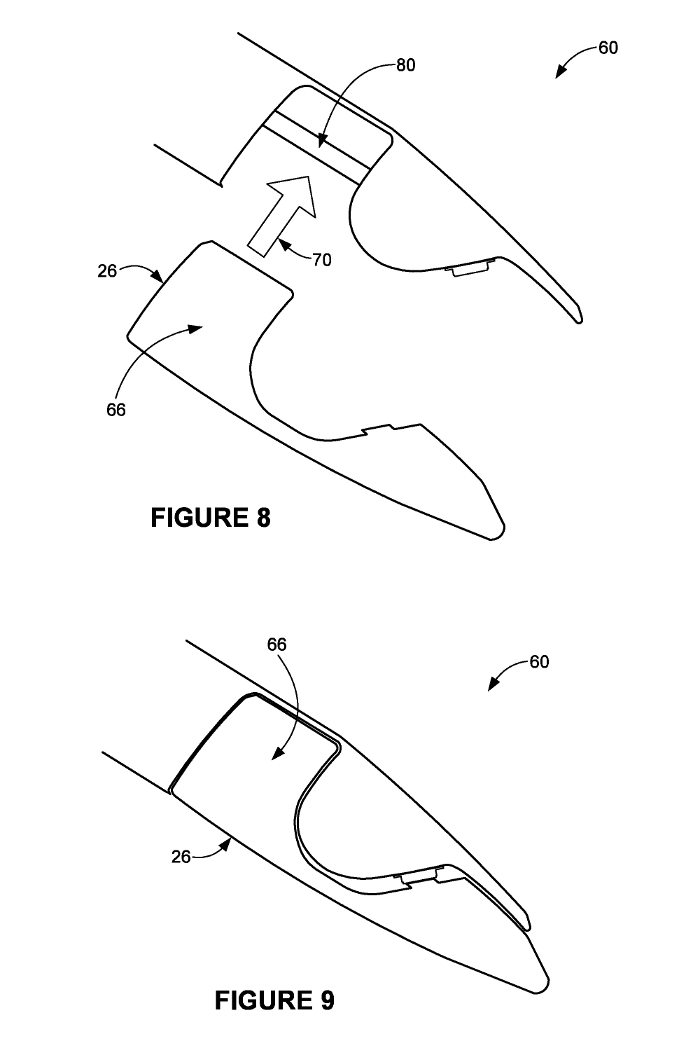

FIG. 8 illustrates an example tip 26 being attached to an example tip region 60 of an example active stylus 20. In particular embodiments, tip 26 being attached to tip region 60 may be referred to as tip 26 being clipped-on to tip region 60 or tip 26 being clipped-on to active stylus 20. In FIG. 8, tip 26 is shown adjacent to tip region 60 with arrow 70 indicating a lateral or sideways movement of tip 26 toward tip region 60. In FIG. 8, as described above, collar 66 may expand or flex open when it comes into contact with and fits over a portion of tip region 60. In particular embodiments, tip region 60 may include a retention feature 80 such as one or more tabs, bumps, protrusions, or raised portions that collar 66 engages with when collar 66 is being mated with tip region 60. In particular embodiments, the ends of collar 66 may slide over retention feature 80 as collar 66 flexes open and tip 26 is attached to tip region 60.

FIG. 9 illustrates the example tip 26 of FIG. 8 after being attached to the example tip region 60 of FIG. 8. In particular embodiments, secure attachment of tip 26 to tip region 60 may be enabled at least in part by a C-shape of collar 66 that wraps around a portion of tip region 60 and by the flexible and rigid properties of materials that tip 26 is made from. In particular embodiments, retention feature 80 may in part provide for a secure attachment of tip 26 to tip region 60. In particular embodiments, retention feature 80 may act to keep tip 26 securely attached to tip region 60 and may prevent tip 26 from becoming accidentally detached from tip region 60. In particular embodiments, tip 26 may be removable from tip region 60 by pulling tip 26 in a sideways, lateral direction away from tip region 60. In particular embodiments, tip 26 may be capable of being clipped-on to and removed from active stylus 20 multiple times. In particular embodiments, tip 26 may be referred to as a replaceable, clip-on tip 26 for an active stylus 20.

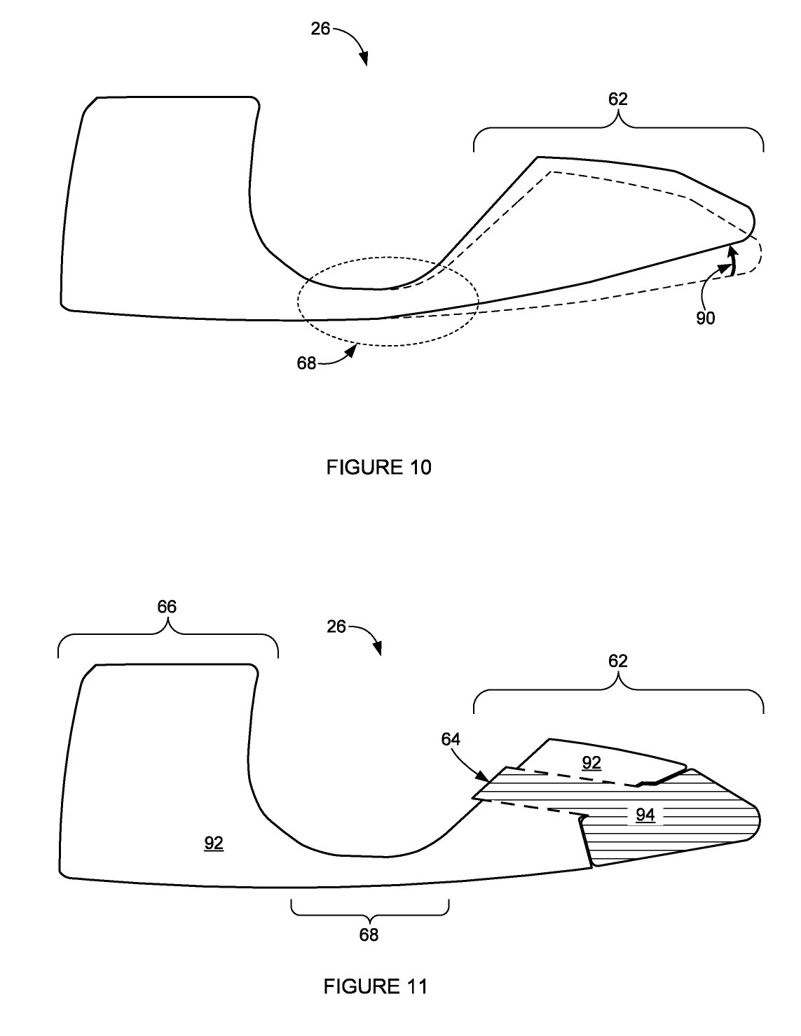

FIG. 10 illustrates an example tip 26 being flexed about an example neck 68. As discussed above, in particular embodiments, neck 68 may flex in response to a force being applied to an end of nib 62, such as for example when a user holds active stylus 20 with a tip 26 clipped-on and presses nib 62 against a surface (e.g., a touch sensor 10 surface). In FIG. 10, the dashed-line portion may represent an unperturbed nib 62, and the solid-line portion of nib 62 may represent displacement of nib 62 when a force is applied. In particular embodiments, flexing of neck 68 may result in a movement or displacement of nib 62 relative to tip region 60 and active stylus 20. In FIG. 10, the amount of flex or displacement may be exaggerated for clarity and for the purpose of illustrating flexing action of tip 26. In FIG. 10, arrow 90 may represent a flexion of neck 68 and a corresponding displacement of nib 62 resulting from an applied force. In particular embodiments, the amount of displacement may be approximately proportional to the amount of force applied to an end of nib 62.

FIG. 11 illustrates a side view of another example tip 26. In FIG. 11, tip 26 may be made from two different materials 92 and 94. In FIG. 11, collar 66 and neck 68 may be made substantially from material 92, and nib 62 may include both materials 92 and 94. Example nib 62 of FIG. 11 is shown in a cross-sectional view that illustrates the shape and extent of the portion made of material 94. In FIG. 11, contact pad 64 is made substantially of material 94, and material 94 extends from contact pad 64 to the end of nib 62. As discussed above, tip 26 in FIG. 11 may be made by joining together two pieces, one piece made of material 92 and another piece made of material 94. In particular embodiments, tip 26 in FIG. 11 may be formed through a twin-shot injection-molding process where materials 92 and 94 are separately injected into a mold in a two-step process. In particular embodiments, material 92 may be an electrically insulating material (e.g., ABS), and material 94 may be an electrically conductive material (e.g., a carbon-filled plastic). In such an example embodiment, the electrically conductive portion made from material 94 may provide an electrically conductive region that extends from contact pad 64 to the end of nib 62. In particular embodiments, an electrically conductive region that extends from contact pad 64 to an end of nib 62 may function as a transmit electrode for sending or transmitting a signal from active stylus 20 to device 52. In particular embodiments, any suitable electrically conductive portion or region of nib 62 may function as an active-stylus 20 transmit electrode. In particular embodiments, an electrically conductive region that is part of nib 62 may function as a receive electrode for receiving a signal sent from device 52 to active stylus 20. Although this disclosure describes and illustrates particular tips 26 made up of particular materials having particular shapes and extents, this disclosure contemplates any suitable tips 26 made up of any suitable materials having any suitable shapes and extents.

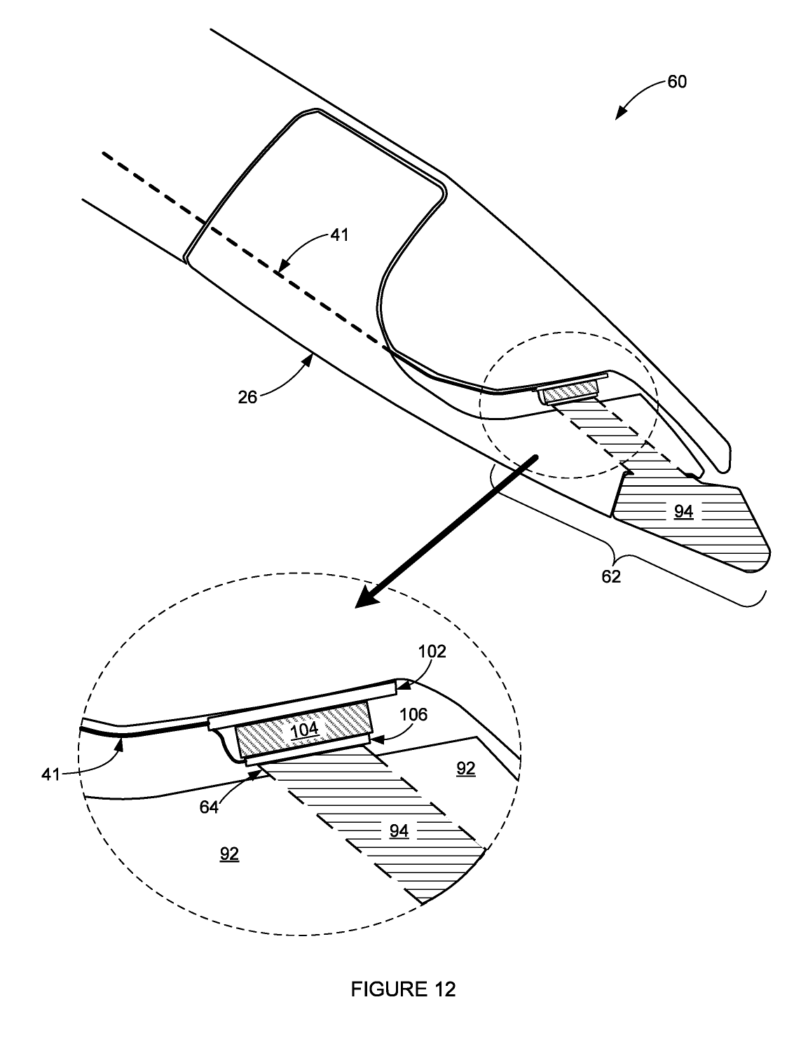

FIG. 12 illustrates an example tip region 60 with example tip 26 of FIG. 11 attached. Portions of nib 62 and tip region 60 in FIG. 12 are shown in a cross-sectional view that illustrates the shape and extent of the portion made of material 94. In FIG. 12, the dashed-line elliptical region is blown-up to show details around contact pad 64. In particular embodiments, contact pad 64 may be in electrical contact with a contact electrode 106 or a portion of an FPC that is part of or is coupled to conduit 41. In particular embodiments, a portion of nib 62 made of electrically conductive material 94 may function as a transmit electrode, and a transmit electrode made of material 94 may be coupled to contact electrode 106, which in turn may be coupled to controller 50 through conduit 41.

In particular embodiments, contact pad 64 may be in mechanical contact with a surface of force sensor 104. In particular embodiments, contact pad 64 may be mechanically engaged with or mechanically coupled to a surface of force sensor 104 through contact electrode 106. As described above, when a force is applied to an end of nib 62, neck 68 may flex, and nib 62 may move relative to tip region 60 and active stylus 20. In particular embodiments, a movement of nib 62 may result in a movement of contact pad 64, which may in turn result in a change in a force applied by contact pad 64 to force sensor 104. In particular embodiments, a force applied to nib 62 may be communicated to or coupled to force sensor 104 by contact pad 64. In particular embodiments, force sensor 104 may provide an electrical signal that represents an amount of force applied to force sensor 104. In particular embodiments, force sensor 104 may be electrically coupled to contact electrode 102, which in turn may be coupled to controller 50 through conduit 41. In particular embodiments, each contact electrode 102 and 106 may include a portion of an FPC that is part of or is coupled to conduit 41.

In particular embodiments, tip 26 may be shaped so that when it is attached to tip region 60, tip 26 may be slightly flexed as a result of a portion of tip 26 (e.g., nib 62) being pressed against a portion of tip region 60 (e.g., force sensor 104 or a contact electrode). In particular embodiments, a slight flexing of tip 26 even when no external force is applied to nib 62 may result in a particular amount of force applied by contact pad 64 to contact electrode 106. In particular embodiments, a slight flexing of tip 26 may ensure a good electrical coupling between electrically conductive material 94 and contact electrode 106. In particular embodiments, tip 26 may be shaped so that when it is attached to tip region 60, tip 26 may be slightly flexed, and contact pad 64 may apply some amount of preload force or offset force to force sensor 104. In particular embodiments, a preload force may result in an initial offset to an electrical force signal provided by force sensor 104 even though there may be no external force applied to nib 62. As an external force is applied to nib 62, the electrical force signal provided by force sensor 104 may change from its initial offset value. In particular embodiments, as a user holds stylus 20 and presses nib 62 against a surface, force sensor 104 may supply a signal to controller 50 corresponding to an amount of force applied at nib 62. In particular embodiments, as an amount of force applied at nib 62 changes, a signal provided by force sensor 104 may change by a corresponding amount.

Herein, reference to a computer-readable non-transitory storage medium or media may include one or more semiconductor-based or other integrated circuits (ICs) (such, as for example, a field-programmable gate array (FPGA) or an application-specific IC (ASIC)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards, SECURE DIGITAL drives, any other suitable computer-readable non-transitory storage medium or media, or any suitable combination of two or more of these, where appropriate. A computer-readable non-transitory storage medium or media may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An active-stylus tip comprising:
a collar comprising substantially flexible material configured to secure the active-stylus tip to an end of an active stylus and enabling the active-stylus tip to be readily removed from the end of the active stylus, the active stylus comprising one or more electrodes and one or more computer-readable non-transitory storage media embodying logic for wirelessly transmitting signals to a device through a touch sensor of the device;
a nib comprising a tapered end opposite the collar, the nib comprising an element opposite the tapered end of the nib and configured to engage a force sensor disposed in the active stylus and communicate a force applied to the nib to the force sensor; and
a neck mechanically connecting the nib to the collar and enabling the active-stylus tip to flex along an extent of the active-stylus tip.

2. The active-stylus tip of claim 1, wherein:
the active-stylus tip is configured to be secured to the end of the active stylus by a first sideways movement of the active-stylus tip, wherein the first sideways movement is directed substantially orthogonal to and toward a longitudinal axis of the active stylus; and
the active-stylus tip is configured to be removed from the end of the active stylus by a second sideways movement of the active-stylus tip, wherein the second sideways movement is directed substantially orthogonal to and away from the longitudinal axis of the active stylus.

3. The active-stylus tip of claim 1, wherein the collar is substantially C-shaped as viewed along a longitudinal axis of the active-stylus tip.

4. The active-stylus tip of claim 1, wherein the active-stylus tip is made of plastic and is formed in an injection-molding process.

5. The active-stylus tip of claim 1, wherein:
one or more portions of the active-stylus tip are made of an electrically insulating material; and
one or more portions of the active-stylus tip are made of an electrically conductive material.

6. The active-stylus tip of claim 5, wherein:
the electrically insulating material comprises acrylonitrile butadiene styrene; and
the electrically conductive material comprises a plastic material and a conductive form of carbon.

7. The active-stylus tip of claim 1, wherein:
a portion of the nib extending from the element opposite the tapered end of the nib to the tapered end of the nib is made of an electrically conductive material;
the element is configured to be electrically coupled to a flexible printed circuit disposed in the active stylus; and
the portion of the nib made of the electrically conductive material is configured to operate as a transmit electrode that receives a signal from the flexible printed circuit and transmits the signal to a device.

8. The active-stylus tip of claim 1, wherein the element opposite the tapered end of the nib comprises a raised portion that protrudes above a surface located opposite the tapered end of the nib and adjacent to the element.

9. The active-stylus tip of claim 1, wherein the force applied to the nib results at least in part from a user holding the active stylus and pressing the nib against the touch sensor of the device.

10. The active-stylus tip of claim 1, wherein the active-stylus tip is configured to apply a preload force to the force sensor when substantially no force is applied to the nib.

11. An active-stylus tip comprising:
first means for securing the active-stylus tip to an end of an active stylus that enables the active-stylus tip to be readily removed from the end of the active stylus, the active stylus comprising one or more electrodes and one or more computer-readable non-transitory storage media embodying logic for wirelessly transmitting signals to a device through a touch sensor of the device;
second means for engaging a force sensor disposed in the active stylus and communicating a force applied to a nib of the active-stylus tip to the force sensor; and
third means for enabling the active-stylus tip to flex along an extent of the active-stylus tip.

12. The active-stylus tip of claim 11, wherein:
the active-stylus tip is configured to be secured to the end of the active stylus by a first sideways movement of the active-stylus tip, wherein the first sideways movement is directed substantially orthogonal to and toward a longitudinal axis of the active stylus; and
the active-stylus tip is configured to be removed from the end of the active stylus by a second sideways movement of the active-stylus tip, wherein the second sideways movement is directed substantially orthogonal to and away from the longitudinal axis of the active stylus.

13. The active-stylus tip of claim 11, wherein the first means is substantially C-shaped as viewed along a longitudinal axis of the active-stylus tip.

14. The active-stylus tip of claim 11, wherein the active-stylus tip is made of plastic and is formed in an injection-molding process.

15. The active-stylus tip of claim 11, wherein:
one or more portions of the active-stylus tip are made of an electrically insulating material; and
one or more portions of the active-stylus tip are made of an electrically conductive material.

16. The active-stylus tip of claim 15, wherein:
the electrically insulating material comprises acrylonitrile butadiene styrene; and
the electrically conductive material comprises a plastic material and a conductive form of carbon.

17. The active-stylus tip of claim 11, wherein:
a portion of the nib extending from an element opposite the tapered end of the nib to a tapered end of the nib is made of an electrically conductive material;
the element is configured to be electrically coupled to a flexible printed circuit disposed in the active stylus; and
the portion of the nib made of the electrically conductive material is configured to operate as a transmit electrode that receives a signal from the flexible printed circuit and transmits the signal to a device.

18. The active-stylus tip of claim 11, wherein the element opposite the tapered end of the nib comprises a raised portion that protrudes above a surface located opposite the tapered end of the nib and adjacent to the element.

19. The active-stylus tip of claim 11, wherein the force applied to the nib results at least in part from a user holding the active stylus and pressing the nib against the touch sensor of the device.

20. The active-stylus tip of claim 11, wherein the active-stylus tip is configured to apply a preload force to the force sensor when substantially no force is applied to the nib.
